(19) United States
(12) Patent Application Publication
(10) Pub. No.: US 2024/0178478 A1
(43) Pub. Date: May 30, 2024

(54) BATTERY COOLING SYSTEM HAVING AN ALTERNATING INLET/OUTLET SYSTEM FOR A VEHICLE

(71) Applicant: GM Global Technology Operations LLC, Detroit, MI (US)

(72) Inventors: Zhen Gao, Shanghai (CN); Jian Yao, Shanghai (CN); Chengwu Duan, Shanghai (CN)

(21) Appl. No.: 18/159,710

(22) Filed: Jan. 26, 2023

(30) Foreign Application Priority Data
Nov. 29, 2022 (CN) 202211508010.7

(51) Int. Cl. H01M 10/6556; H01M 10/613; H01M 10/625; H01M 10/63

(52) U.S. Cl. CPC H01M 10/6556; H01M 10/613; H01M 10/625; H01M 10/63; H01M 2220/20

(57) ABSTRACT

A battery assembly including a housing having a first coolant port and a second coolant port includes a valve assembly fluidically connected to one of the first coolant port and the second coolant port, a pump fluidically connected to the valve assembly and the battery assembly, and a coolant controller operatively connected to the pump and the valve assembly. The coolant controller is operable to control the valve assembly to pass a flow of coolant into the one of the first coolant port and the second coolant port for a first time period and to pass the flow of coolant into the other of the first coolant port and the second coolant port for a second time period.

### CROSS-REFERENCE TO RELATED APPLICATIONS

This application claims priority to Chinese Patent Application No. 202211508010.7, filed Nov. 29, 2022, the contents of which are incorporated by reference herein in their entirety.

### INTRODUCTION

The subject disclosure relates to battery cooling systems for vehicles and, more particularly, to a battery cooling system having an alternating inlet/outlet system.

Many newer vehicles are being manufactured with electric propulsion systems. The electric propulsion system, be it a full electric system or a hybrid electric system, relies on an electric motor that is powered by energy stored in a battery. While in operation, the battery generates heat. The heat detracts from battery efficiency. In order to reduce heat produced by the battery, many vehicles include a cooling system that passes a cooling fluid through the battery.

The cooling fluid passes into an inlet, then in a heat exchange relationship with battery cells before passing through an outlet. The cooling fluid may pass through a heat exchanger before being reintroduced into the inlet. While passing in the heat exchange relationship with the battery cells, the cooling fluid begins to entrap or absorb and retain heat. As such, battery cells near the inlet may experience a greater cooling effect than those near the outlet. In certain systems, a three-degree (3°) temperature difference may be perceived by the battery. This temperature difference detracts from battery performance and charging efficiency. Accordingly, it is desirable to provide a system to uniformly cool battery cells in a vehicle.

### SUMMARY

A battery assembly including a housing having a first coolant port and a second coolant port, in accordance with a non-limiting example, includes a valve assembly fluidically connected to one of the first coolant port and the second coolant port, a pump fluidically connected to the valve assembly and the battery assembly, and a coolant controller operatively connected to the pump and the valve assembly. The coolant controller is operable to control the valve assembly to pass a flow of coolant into the one of the first coolant port and the second coolant port for a first time period and to pass the flow of coolant into the other of the first coolant port and the second coolant port for a second time period.

In addition to one or more of the features described herein the valve assembly includes a first valve fluidically connected to the first coolant port and the pump and a second valve fluidically connected to the second coolant port and the pump.

In addition to one or more of the features described herein the first valve comprises a first spool valve including a first port, a second port, a third port, a fourth port, and a fifth port.

In addition to one or more of the features described herein the first port is selectively fluidically connected to the second port in a first configuration of the first spool valve and the first port is fluidically connected to the third port and the fourth port is fluidically connected to the fifth port in a second configuration of the first spool valve.

In addition to one or more of the features described herein the second valve comprises a second spool valve including a first port member, a second port member, and a third port member.

In addition to one or more of the features described herein the first port member is fluidically connected to the second port member in a first configuration of the second spool valve and the second port member is fluidically connected to the third port member in a second configuration of the second spool valve.

In addition to one or more of the features described herein the battery cooling system further includes a valve controller and a temperature sensor, the valve controller being operable to switch the first spool valve and the second spool valve between the first configuration and the second configuration based on a temperature sensed by the temperature sensor.

In addition to one or more of the features described herein a heat exchanger is fluidically connected to the pump.

A vehicle in accordance with a non-limiting example includes a body, an electric motor supported relative to the body and a battery assembly operatively connected to the electric motor. The battery assembly includes a housing having a first coolant port and a second coolant port. A battery cooling system is fluidically connected to the first coolant port and the second coolant port. The battery cooling system includes a valve assembly fluidically connected to one of the first coolant port and the second coolant port, a pump fluidically connected to the valve assembly and the battery assembly, and a coolant controller operatively connected to the pump and the valve assembly. The coolant controller is operable to control the valve assembly to pass a flow of coolant into the one of the first coolant port and the second coolant port for a first time period and to pass the flow of coolant into the other of the first coolant port and the second coolant port for a second time period.

In addition to one or more of the features described herein the valve assembly includes a first valve fluidically connected to the coolant inlet and the pump and a second valve fluidically connected to the coolant outlet and the pump.

In addition to one or more of the features described herein the first valve comprises a first spool valve including a first port, a second port, a third port, a fourth port, and a fifth port.

In addition to one or more of the features described herein the first port is selectively fluidically connected to the second port in a first configuration of the first spool valve and the first port is fluidically connected to the third port and the fourth port is fluidically connected to the fifth port in a second configuration of the first spool valve.

In addition to one or more of the features described herein the second valve comprises a second spool valve including a first port member, a second port member, and a third port member.

In addition to one or more of the features described herein the first port member is fluidically connected to the second port member in a first configuration of the second spool valve and the second port member is fluidically connected to the third port member in a second configuration of the second spool valve.

In addition to one or more of the features described herein the cooling system further includes a valve controller and a temperature sensor, the valve controller being operable to switch the first spool valve and the second spool valve between the first configuration and the second configuration based on a temperature sensed by the temperature sensor.

In addition to one or more of the features described herein a heat exchanger is fluidically connected to the pump.

A method of cooling a vehicle battery including a housing having a first coolant port and a second coolant port includes passing a flow of coolant into the housing through the first coolant port, flowing the flow of coolant through the housing, expelling the flow of coolant through the second coolant port, and reversing the flow of coolant.

In addition to one or more of the features described herein the method also includes monitoring one of an accumulated thermal load and an accumulated electric load of the vehicle battery assembly and reversing the flow of coolant when the one of the accumulated thermal load and the accumulated electric load exceeds a predetermined threshold.

In addition to one or more of the features described herein monitoring the one of the accumulated thermal load and the accumulated electric load includes sensing a temperature of energy storage cells near the second coolant port.

In addition to one or more of the features described herein the method also include determining a status of a vehicle having the battery assembly and reversing the flow of coolant when the one of the accumulated thermal load and the accumulated electric load exceeds the predetermined threshold and the vehicle is in a predetermined status.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side plan view of a vehicle including a battery cooling system having an alternating inlet/outlet system, in accordance with a non-limiting example;

FIG. 2 is a schematic view of a vehicle battery connected to a battery cooling system depicting a forward coolant flow, in accordance with a non-limiting example;

FIG. 3 is a schematic view of the vehicle battery connected to the battery cooling system of FIG. 3 depicting a reverse coolant flow, in accordance with a non-limiting example;

FIG. 4 is a schematic view of a first valve of the battery cooling system in a first flow configuration, in accordance with a non-limiting example;

FIG. 5 is a schematic view of the first valve of FIG. 4 in a second flow configuration, in accordance with a non-limiting example;

FIG. 6 is a schematic view of a second valve of the battery cooling system, in a first flow configuration, in accordance with a non-limiting example;

FIG. 7 is a schematic view of the second valve of FIG. 5 in a second flow configuration, in accordance with a non-limiting example; and

FIG. 8 is a flow chart depicting a method of cooling a battery with the battery cooling system, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

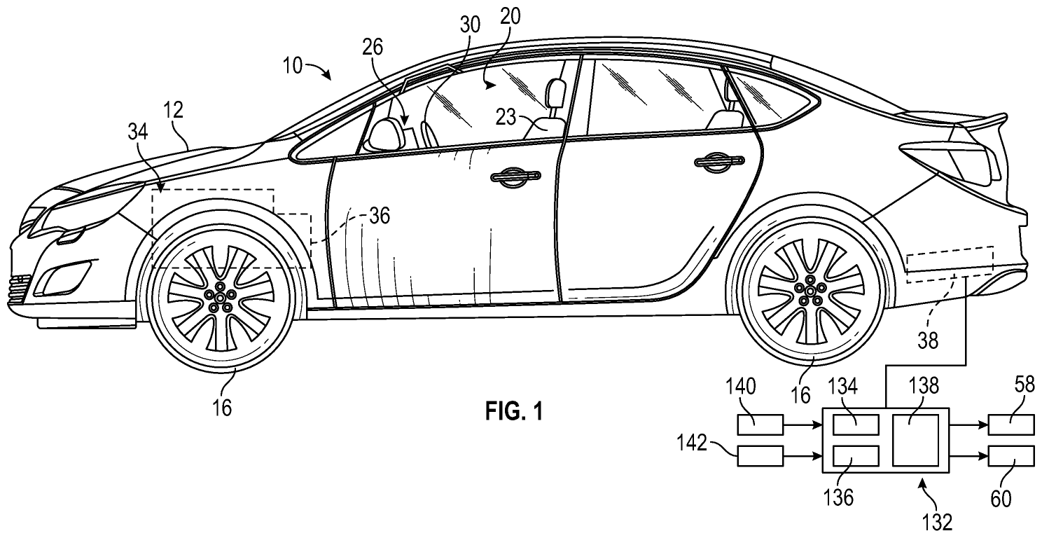

A vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. That is, changing a position of two of the plurality of wheels 16 relative to body 12 will cause vehicle 10 to change direction. Body 12 defines, in part, a passenger compartment 20 having seats 23 positioned behind a dashboard 26. A steering control 30 is arranged between seats 23 and dashboard 26. Steering control 30 is operated to control orientation of the steerable wheel(s).

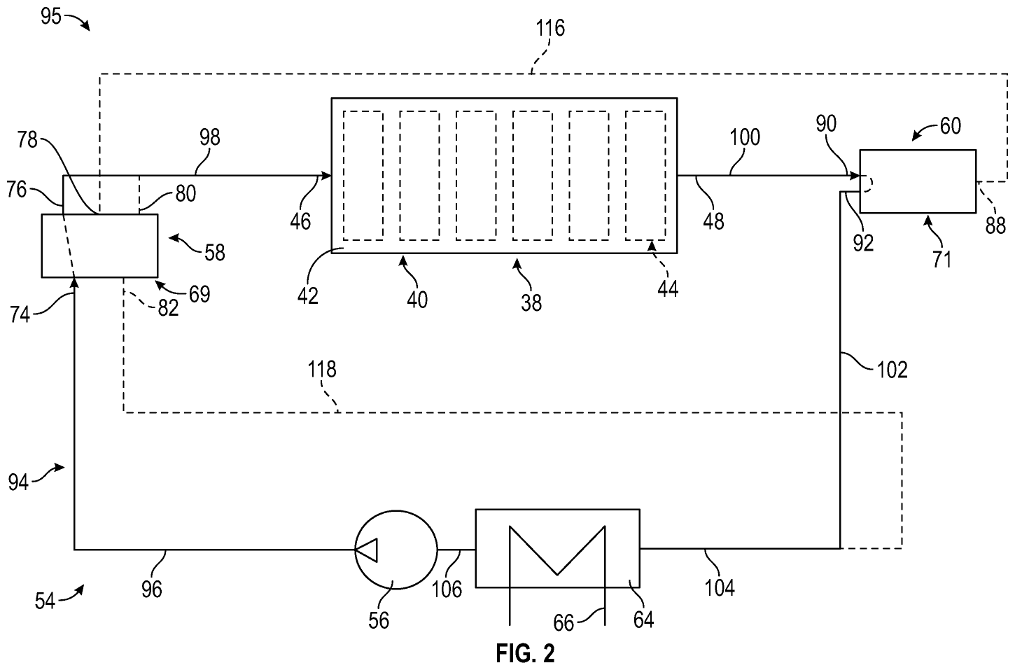

Vehicle 10 includes an electric motor 34 connected to a transmission 36 that provides power to one or more of the plurality of wheels 16. A rechargeable energy storage system (RESS) or battery assembly 38 provides power to electric motor 34. Referring to FIG. 2, battery assembly 38 includes a housing 40 having an interior portion 42 within which is arranged a plurality of energy storage cells 44. Housing 40 includes a first coolant port 46 and a second coolant port 48. First and second coolant ports 46 and 48, as will be defined herein, provide connection points for a battery cooling system 54 that drives a coolant through housing 40 to absorb heat from energy storage cells 44 and then exit housing 40.

With continued reference to FIG. 2, battery cooling system 54 includes a pump 56 fluidically connected to a first valve 58 and a second valve 60. While shown as two separate elements, it should be understood that first valve 58 and second valve 60 could be integrated into a single structure. Cooling system 54 also includes a heat exchanger 64 having a heat removal circuit 66. Heat removal circuit 66 flows a heat removal medium in a thermally conductive relationship with coolant passing from battery assembly 38 as will be detailed more fully herein.

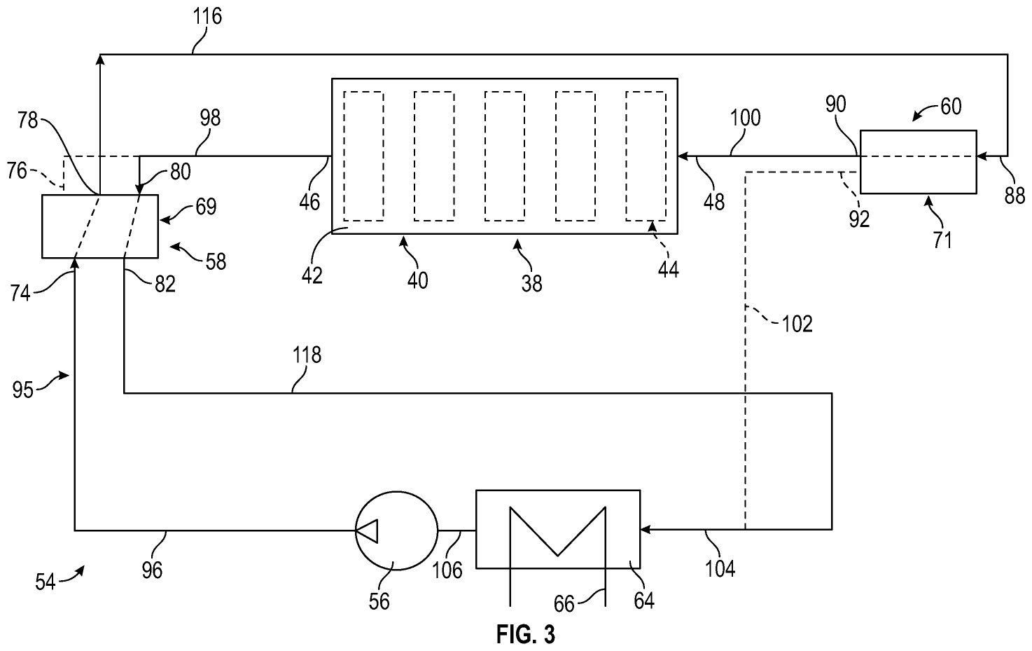

In a non-limiting example, first valve 58 takes the form of a first spool valve 69 and second valve 60 takes the form of a second spool valve 71. First spool valve 69 includes a first port 74, a second port 76, a third port 78, a fourth port 80, and a fifth port 82. Second spool valve 71 includes a first port member 88, a second port member 90, and a third port member 92. As will be described herein, first spool valve 69 and second spool valve 71 are selectively activated to establish a first coolant circuit 94 (FIG. 2) and a second coolant circuit 95 (FIG. 3) for battery cooling system 54.

In accordance with a non-limiting example, first coolant circuit 94 FIG. 2) delivers coolant into first coolant port 46 and carries coolant from second coolant port 48 to heat exchanger 64 and second coolant circuit 95 (FIG. 3) introduces coolant into second coolant port 48 and carries coolant from first coolant port 46 to heat exchanger 64. By alternating which coolant port 46/48 is an inlet, energy storage cells 44 experience a more uniform cooling effect. At this point it should be understood that the following arrangement of components is exemplary, other plumbing frameworks may be employed to carry out the two-way flow described herein.

In a non-limiting example, cooling system 54 includes a first conduit 96, a second conduit 98, a third conduit 100, a fourth conduit 102, a fifth conduit 104, and a sixth conduit 106, a seventh conduit 116 and an eighth conduit 118. As shown in FIG. 2, first coolant circuit 94 relies upon first conduit 96, second conduit 98, third conduit 100, fourth conduit 102, fifth conduit 104, and sixth conduit 106 to circulate fluid through battery cooling system 54. Second cooling circuit 95 in addition to relying on first conduit 96, second conduit 98, third conduit 100, fifth conduit 104, and a sixth conduit 106 also relies upon seventh conduit 116 and eighth conduit 118 to circulate fluid through cooling system 54.

A valve controller 132 (FIG. 1) is connected to first valve 58 and second valve 60. Valve controller 132 selectively controls first valve 58 and second valve 60 to establish the fluidic connections to form first coolant circuit 94 and second coolant circuit 95. Valve controller 132 includes a central processor unit (CPU) 134, a non-volatile memory module 136, and a valve control module 138. In addition to connections with first valve 58 and second valve 60, valve controller 132 is also operatively connected to a sensor(s) 140 that may be arranged in housing 40, and a vehicle state sensor 142. Sensor(s) 140 may be temperature sensors, current sensors, or combinations thereof.

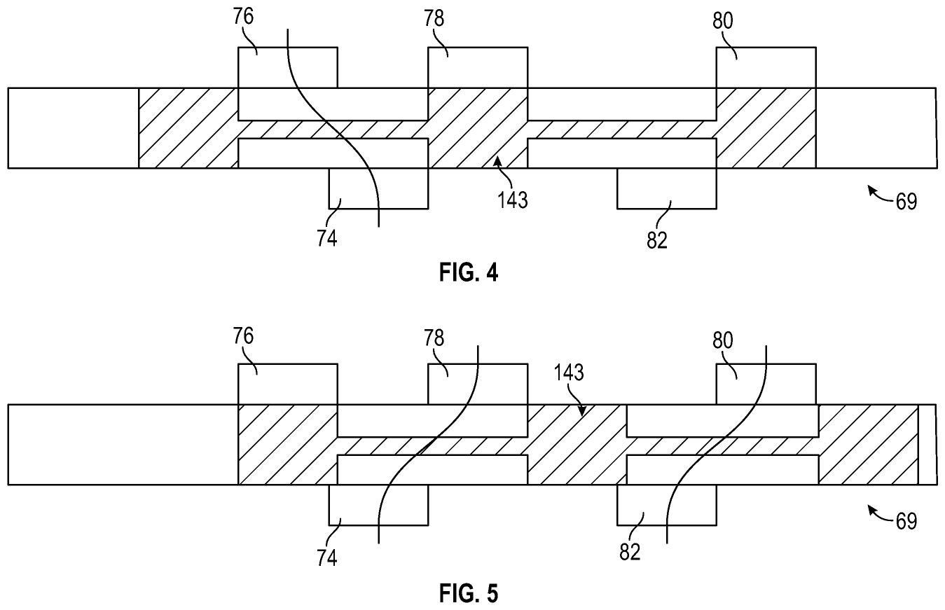

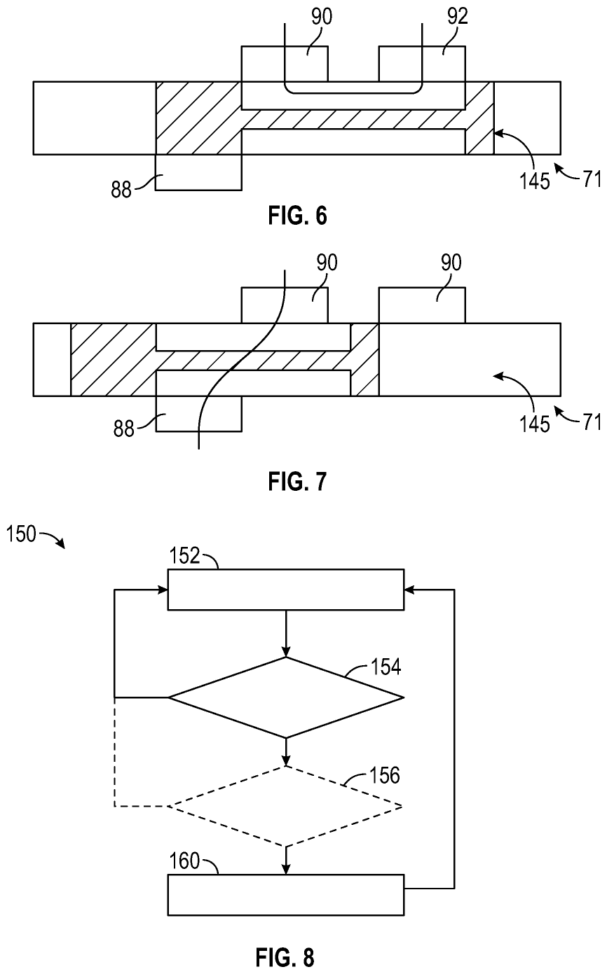

Reference will now follow to FIGS. 4 and 5 in describing first and second configurations of first spool valve 69. First spool valve 69 includes a first spool 143 that selectively shifts between a first configuration (FIG. 4) establishing first coolant circuit 94 and a second configuration (FIG. 5) establishing second coolant circuit 95. FIGS. 6 and 7 depict first and second configurations of second spool valve 71. Second spool valve 71 includes a second spool 145 that selectively shifts between a first configuration (FIG. 6) establishing first coolant circuit 94 and a second configuration (FIG. 7) establishing second coolant circuit 95.

In the first configuration, first spool 143 is shifted to fluidically connect first port 74 and second port 76 thereby connecting first conduit 96 and second conduit 98. At the same time, second spool 145 is shifted to fluidically connect second port member 90 and third port member 92 to connect third conduit 100 and fourth conduit 102 to create the first coolant circuit 94. In this configuration, coolant flows from pump 56, through first conduit 96 into first valve 58 and then on into battery assembly 38 via first coolant port 46.

At this point, the coolant flows through housing 40 in a heat exchange relationship with energy storage cells 44 and exits battery assembly 38 via second coolant port 48. The coolant flows through third conduit 100 into second valve 60 and then through fourth conduit 102, through fifth conduit 104, and into heat exchanger 64 to transfer heat to heat removal circuit 66. From heat exchanger 64 the coolant passes through sixth conduit 106 and back to pump 56.

As will be detailed more fully herein, first and second valves 58 and 60 remain in the first configuration (FIG. 4 and FIG. 6 respectively) until valve controller 132 determines that a temperature in housing 40 exceeds a predetermined threshold stored in non-volatile memory module 136. At such a time, first and second valves 58 and 60 transition to the second configuration (FIG. 5 and FIG. 7 respectively) to establish second cooling circuit 95. In the first configuration, valve controller 132 may be detecting temperatures in select ones of energy storage cells 44 adjacent second coolant port 48 or may detect a temperature gradient in housing 40 that exceeds a predetermined threshold.

When temperatures in housing 40 exceed the predetermined threshold, valve controller 132 signals valve control module 138 to shift first and second spools 143 and 145 to establish the second configuration FIG. 5 and FIG. 7. Shifting to the second configuration may also be based on vehicle state, (i.e., vehicle is not moving). In the second configuration, first spool 143 is shifted (FIG. 5) such that first port 74 is fluidically connected to third port 78 thereby connecting first conduit 96 and seventh conduit 116 and fourth port 80 is fluidically connected to fifth port 82 thereby connecting second conduit 98 with eighth conduit 118.

Also in the second configuration, second spool 145 is shifted (FIG. 7) to fluidically connect first port member 88 with second port member 90 so as to connect seventh conduit 116 with third conduit 100. In this configuration, a reverse coolant flow is established. That is, coolant flows from pump 56 through first conduit 96 into first valve 58. The coolant exits first valve 58 and passed into seventh conduit 116. The coolant enters second valve 60 and exists into third conduit 100 before entering battery assembly 38 via second coolant port 48.

At this point, the coolant flows through housing 40 in a heat exchange relationship with energy storage cells 44 and exits battery assembly 38 via first coolant port 46 and flows back into first valve 58. The coolant exits first valve 58 and flows into eighth conduit 118 before passing into fifth conduit 104 and back into heat exchanger 64. As will be detailed more fully herein, first and second valves 58 and 60 remain in the second configuration (FIG. 5 and FIG. 7 respectively) until valve controller 132 determines that temperature in housing 40 exceeds a predetermined threshold stored in non-volatile memory module 136. In the second configuration, valve controller 132 may be detecting temperatures in select ones of energy storage cells 44 adjacent first coolant port 46 or may detect a temperature gradient in housing 40 that exceeds a predetermined threshold. At this point, first coolant circuit 94 may be re-established and the process repeated.

Reference will now follow to FIG. 8 in describing a method 150 of creating a uniform temperature environment within housing 40. In a non-limiting example, valve controller 132 monitors temperatures of sensor(s) 140 arranged in housing 40 in block 152. In block 154, a determination is made whether an accumulated thermal loading and/or an accumulated electric loading exceeds the predetermined threshold stored in non-volatile memory module. Accumulated thermal loading and/or accumulated electrical loading may be detected as a change in current over time or a change in temperature over time by sensor(s) 140. If the predetermined temperature threshold is exceeded in block 154, a determination may be made in block 156 as to current vehicle status. Vehicle status may include whether vehicle 10 is stopped. If programmed to look at vehicle status, and vehicle 10 is stopped, at this point, valve control module 138 may signal first and second valves 58 and 60 to change position in block 160 and the process returns to block 152.

At this point, it should be understood that the non-limiting example described herein provides a system for creating a forward and reverse flow through a battery housing in order to eliminate hot spots or increased temperature areas that may develop near a coolant exit in a one-way coolant flow system.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly including a housing having a first coolant port and a second coolant port and a battery cooling system comprising:
a valve assembly fluidically connected to one of the first coolant port and the second coolant port;
a pump fluidically connected to the valve assembly and the battery assembly; and
a coolant controller operatively connected to the pump and the valve assembly, the coolant controller being operable to control the valve assembly to pass a flow of coolant into the one of the first coolant port and the second coolant port for a first time period and to pass the flow of coolant into the other of the first coolant port and the second coolant port for a second time period.

2. The battery cooling system according to claim 1, wherein the valve assembly includes a first valve fluidically connected to the first coolant port and the pump and a second valve fluidically connected to the second coolant port and the pump.

3. The battery cooling system according to claim 2, wherein the first valve comprises a first spool valve including a first port, a second port, a third port, a fourth port, and a fifth port.

4. The battery cooling system according to claim 3, wherein the first port is selectively fluidically connected to the second port in a first configuration of the first spool valve and the first port is fluidically connected to the third port and the fourth port is fluidically connected to the fifth port in a second configuration of the first spool valve.

5. The battery cooling system according to claim 3, wherein the second valve comprises a second spool valve including a first port member, a second port member, and a third port member.

6. The battery cooling system according to claim 5, wherein the first port member is fluidically connected to the second port member in a first configuration of the second spool valve and the second port member is fluidically connected to the third port member in a second configuration of the second spool valve.

7. The battery cooling system according to claim 6, further comprising a valve controller and a temperature sensor, the valve controller being operable to switch the first spool valve and the second spool valve between the first configuration and the second configuration based on a temperature sensed by the temperature sensor.

8. The battery cooling system according to claim 1, further comprising a heat exchanger fluidically connected to the pump.

9. A vehicle comprising:
a body;
an electric motor supported relative to the body;
a battery assembly operatively connected to the electric motor, the battery assembly including a housing having a first coolant port and a second coolant port; and
a battery cooling system fluidically connected to the first coolant port and the second coolant port, the battery cooling system comprising:
a valve assembly fluidically connected to one of the first coolant port and the second coolant port;
a pump fluidically connected to the valve assembly and the battery assembly; and
a coolant controller operatively connected to the pump and the valve assembly, the coolant controller being operable to control the valve assembly to pass a flow of coolant into the one of the first coolant port and the second coolant port for a first time period and to pass the flow of coolant into the other of the first coolant port and the second coolant port for a second time period.

10. The vehicle according to claim 9, wherein the valve assembly includes a first valve fluidically connected to the first coolant port and the pump and a second valve fluidically connected to the second coolant port and the pump.

11. The vehicle according to claim 10, wherein the first valve comprises a first spool valve including a first port, a second port, a third port, a fourth port, and a fifth port.

12. The vehicle according to claim 11, wherein the first port is selectively fluidically connected to the second port in a first configuration of the first spool valve and the first port is fluidically connected to the third port and the fourth port is fluidically connected to the fifth port in a second configuration of the first spool valve.

13. The vehicle according to claim 11, wherein the second valve comprises a second spool valve including a first port member, a second port member, and a third port member.

14. The vehicle according to claim 13, wherein the first port member is fluidically connected to the second port member in a first configuration of the second spool valve and the second port member is fluidically connected to the third port member in a second configuration of the second spool valve.

15. The vehicle according to claim 14, further comprising a valve controller and a temperature sensor, the valve controller being operable to switch the first spool valve and the second spool valve between the first configuration and the second configuration based on a temperature sensed by the temperature sensor.

16. The vehicle according to claim 9, further comprising a heat exchanger fluidically connected to the pump.

17. A method of cooling a vehicle battery assembly including a housing having a first coolant port and a second coolant port, the method comprising:
passing a flow of coolant into the housing through the first coolant port;
flowing the flow of coolant through the housing;
expelling the flow of coolant through the second coolant port; and
reversing the flow of coolant.

18. The method of claim 17, further comprising monitoring one of an accumulated thermal load and an accumulated electric load of the vehicle battery assembly and reversing the flow of coolant when the one of the accumulated thermal load and the accumulated electric load exceeds a predetermined threshold.

19. The method of claim 18, wherein monitoring the one of the accumulated thermal load and the accumulated electric load includes sensing a temperature of energy storage cells near the second coolant port.

20. The method of claim 18, further comprising determining a status of a vehicle having the battery assembly and reversing the flow of coolant when the one of the accumulated thermal load and the accumulated electric load exceeds the predetermined threshold and the vehicle is in a predetermined status.
